(19) United States
(12) Patent Application Publication
(10) Pub. No.: US 2006/0136635 A1
(43) Pub. Date: Jun. 22, 2006

(54) Very little multi master bus

(76) Inventors: Denis R. Beaudoin, Rowlett, TX (US); Christopher S. Tracy, Frisco, TX (US); Brian J. Karguth, Van Alstyne, TX (US)

Correspondence Address: TEXAS INSTRUMENTS INCORPORATED, P O BOX 655474, M/S 3999, DALLAS, TX, 75265, US

(21) Appl. No.: 11/020,830

(22) Filed: Dec. 22, 2004

(51) Int. Cl. G06F 13/00

(52) U.S. Cl. 710/111

(57) ABSTRACT

A method and an apparatus for communication among multiple devices on a data bus with relatively few connections to the bus and reduced logic for enumeration, arbitration, and data flow control is described. A Very Little Multi Master Bus (VLMMB) couples various devices in a bit-rotated manner. When one or more devices seek ownership (control) of the bus, that device raises its assigned bus request line to a predetermined logic (e.g., “1” or “0”). Because there are as many bus request lines as devices, each device can “see” the devices requesting the ownership of the bus. If multiple devices request ownership, the requesting devices determine which one gains ownership by a hierarchical, round-robin, or similar logical decision.

### BACKGROUND

1. Field of the Invention

This disclosure relates to inter-device data communication buses in general, and, in particular, to a multi master bus enabling coupled devices to have reduced bus pin count and reduced logic for device enumeration and bus arbitration.

2. Description of the Related Art

Data communication among electronic devices typically uses a parallel and/or a serial bus. A bus is a multiplicity of connections among devices, each connection having a defined function. Digital data is typically in the form of multi-bit “words” such as 8 bits (a “byte”). Wider data words—for example 32 or 64 bits—are used in high-speed system architectures to enable processing of more data per unit of time (clock transition or cycle).

A parallel bus passes multiple bits (typically one or more words) on each clock transition, using one connection for each bit in the word. An example of a known parallel bus is the PCI bus, widely used in personal computers (PC's). The advantage of the parallel bus is that many data bits are transferred per clock cycle, increasing data transfer speed for a given number of clock cycles. For example, a 32-bit bus will pass 32 bits of information each cycle.

Some systems utilizing a parallel bus have a second bus for address data, adding many more lines to the bus. Other systems send address words and data words sequentially, on the same bus. Additional wires or traces are typically required for a clock signal, flow control signals, device enumeration signals, and bus arbitration signals. The resulting parallel buses for complex systems thus require large numbers of conductive traces on a printed wiring board (PWB), leading to increased PWB area, potential for crosstalk between traces, and reduced reliability, especially as trace widths become narrow.

The serial bus uses a smaller number of connections between devices, transmitting data bits sequentially rather than in parallel. A typical serial bus is point-to-point, connecting two devices, and has a first connection for data, sent one bit at a time, and a second connection for a clock signal having a transition per bit time. An example of a serial bus is the IEEE1394 (Firewire) bus used for high-speed data transfer from PC's to peripheral devices such as video cameras. A serial bus typically sends control, address, and data on the same connection, so well-defined signaling protocols must be developed. For example, a serial data packet might include bits uniquely defining the destination device for the packet, the memory address to which the data will be stored, the length of the data to be sent, and finally the data itself. The logic required to decode such a protocol, especially when multiple devices share the bus, can be complex, increasing device size and power consumption.

Buses connecting only two devices are known as point-to-point, simplifying communication because each device knows that any message coming to it can only be coming from a single known device. Often such point-to-point connections have a clear master-slave hierarchy, wherein the single master controls all aspects of bus communication; an example is a PC (master) coupled to a printer (slave). Some such buses have a forward data path (device 1 to device 2) and a reverse path (device 2 to device 1), allowing concurrent bidirectional data transfer device to device, but having the disadvantage of requiring a larger number of interconnecting traces.

More complex buses connect multiple devices, and allow more than one device to be the master. The device which is the master takes control of bus activity, and controls the flow of data on the bus to prevent multiple devices placing data on the bus at the same time. Devices coupled to this type of bus often must be able to communicate with any other device on the bus, even supporting near-simultaneous communication among two or more sets of devices.

Buses connecting a plurality of devices typically require enumeration, arbitration, and flow control. Enumeration is the process by which each device on the bus is assigned a unique identification, used as a form of device address during bus communication; arbitration is the process by which it is determined which device on the bus will gain control of the bus next (become the master); flow control is the process by which the flow of data from one device to others can be interrupted and restarted. For example, if the receiving device has a more urgent task to complete or is low on receive buffer memory, it can refuse a data transfer, or interrupt a transfer in process. Flow control also typically manages the hierarchy of data types, allowing more time-critical data to interrupt the transfer of data types of lower time sensitivity. Flow control is useful in systems passing video or voice data, such as Voice Over Internet Protocol (VOIP). In VOIP systems, speech delays longer than tens of milliseconds can be noticeable and annoying to the speakers. Flow control can be used to set the maximum allowable delay or latency in such an application.

A class of data bus often used for such data communication among multiple devices is called Multi Master Bus (MMBUS). Each device on such a bus can act as master to gain control of the bus, for example when it needs to pass data from itself to another device on the bus, or request data from another device on the bus. Various hierarchical or round-robin approaches to handling contention for the bus have been developed. Arbitration and flow control in MMBUS architectures typically requires additional logic in each device on the system, and additional connections (bus lines) among devices.

It is desirable to minimize the number of lines the bus requires, minimize the required logic (hardware and software) in each device, maximize the data throughput (bits per clock cycle), and provide efficient flow control and bus arbitration.

### SUMMARY OF THE INVENTION

The present application describes a method and an apparatus for communication among multiple devices on a data bus with relatively few connections to the bus and reduced logic for enumeration, arbitration, and data flow control. A Very Little Multi Master Bus (VLMMB) couples various devices in a bit-rotated manner. When one or more devices seek ownership (control) of the bus, that device raises its assigned bus request line to a predetermined logic (e.g., “1” or “0”). Because there are as many bus request lines as devices, each device can “see” the devices requesting the ownership of the bus. If multiple devices request ownership, the requesting devices determine which one gains ownership by a hierarchical, round-robin, or similar logical decision. Hierarchical systems assign each device a priority, and the highest priority device needing bus ownership wins arbitration. Round-robin systems keep track of which device last had bus ownership, and devices take turns gaining ownership. Systems can also use a combination of hierarchical and round-robin. Whichever approach is used, all devices that determine they should not have ownership drop their bus request line, leaving a single device with the bus request line asserted. This device then has the ownership until such time that arbitration begins again.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

FIG. 1 is a diagram of a known parallel bus (PCI).

FIG. 2 is a block diagram of a system having multiple logical devices coupled using an exemplary embodiment of the Very Little Multi Master Bus (VLMMB).

FIG. 3 is a timing diagram of the VLMMB, with multiple devices requesting bus ownership.

FIG. 4 is a timing diagram of the VLMMB, with a single device requesting bus ownership.

FIG. 5 is a timing diagram illustrating the clock stopping when no ownership requests are present, and restarting when one or more devices on the VLMMB request ownership.

FIG. 6 is a timing diagram illustrating data flow control on the VLMMB.

### DETAILED DESCRIPTION

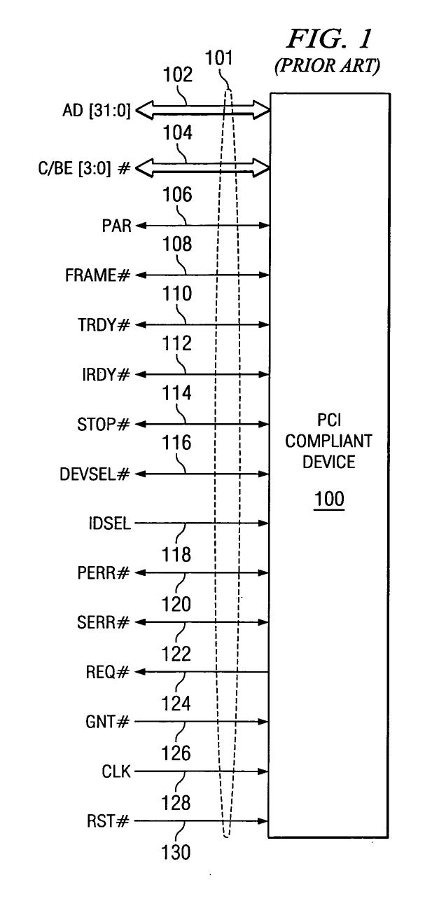

FIG. 1 is a diagram of a known parallel bus (PCI) 101. A PCI compliant device 100 is coupled to the bus 101 via multiplicity of pins labeled 102 through 130. Lines AD[31:0] (address/data) labeled 102 are a group of 32 lines which carry, sequentially, address and data bytes. Multiplexing address and data information on these 32 lines cuts in half the number of lines required, compared to having separate lines for address and data. Lines C/BE[3:0] (command/bus enable) labeled 104 are a group of 4 lines which carry information as to what type of data transfer is requested. The PAR (parity) line 106 carries parity information for error detection. The group of 6 lines including FRAME 108, TRDY 110, IRDY 112, STOP 114, DEVSEL 116, and IDSEL 118 control the flow of data from device to device, selecting a destination device and starting and stopping data flow to and from the device as required. Lines REQ (request) 124 and GNT (grant) 126 are used for arbitration of ownership of the bus. Lines PERR 120 and SERR 122 indicate data transmission errors. Lines CLK (clock) 128 and RST (reset) 130 are clock input and reset command inputs respectively. The lines and corresponding signals detailed above implement the minimal PCI bus, yet require 49 data and signaling pins (plus power and ground). Arbitration and flow control functions use lines separate from the data lines.

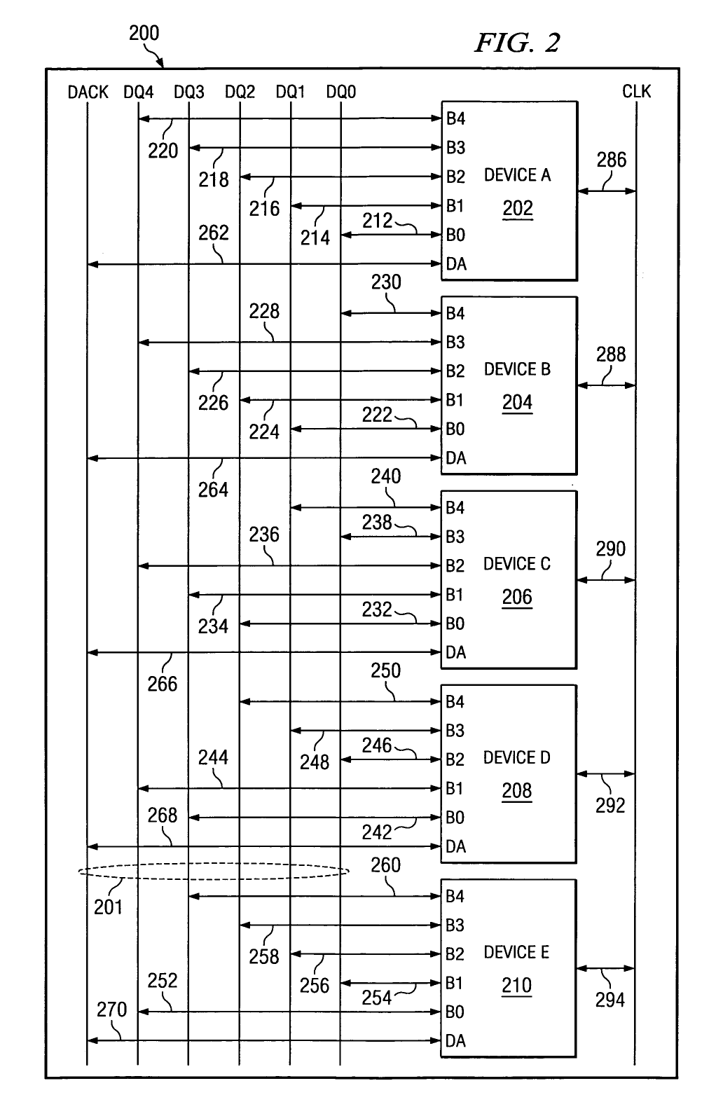

FIG. 2 is a block diagram of a system 200 having multiple logical devices coupled to each other using an exemplary embodiment of the Very Little Multi Master Bus (VLMMB). System 200 includes five devices 202, 204, 206, 208, and 210 coupled to a data communication bus 201 comprising five data lines DQ0, DQ1, DQ2, DQ3, and DQ4; an acknowledge line DACK, and a clock line CLK. Each of the five devices has a clock input 286, 288, 290, 292, 294 respectively, each having as input or providing as output a clock signal to or from the clock line CLK. Each device also has a data acknowledge connection DA (262, 264, 266, 268, and 270 respectively) coupled to the bus line DACK. The DACK line is used for flow control as will be described later. Each device also has multiple data pins, e.g. five lines in this example, each line carrying a digital signal either into or from the device. Pin B0 (212, 222, 232, 242, 252) on each device typically carries the least significant bit (LSB) of data, while B3 (218, 228, 238, 248, 258) typically carries the most significant bit (MSB) of data; intermediate pins B1 (214, 224, 234, 244, 254), and B2 (216, 226, 236, 246, 256) complete the 4-bit parallel data connection to and from the device. The data line B4 facilitates bus arbitration as described later.

The pin B0-212 of device 202 is coupled to line DQ0 of the bus 201; the following pins of device 202 are then coupled as follows—B1 214 to DQ1, B2 216 to DQ2, B3 to DQ3, and B4 220 to DQ4. The second device 204 has its pins B0 through B4 also coupled to bus lines DQ0 through DQ4, but one bit rotated with respect to the connections of the device 202. That is, B0 222 of the device 204 is coupled to DQ1, B1 224 is coupled to DQ2, B2 is coupled to DQ3, B3 is coupled to DQ4, and B4 230 is coupled to DQ0. On the third device 206, B0 232 is coupled to DQ2, B1 234 is coupled to DQ3, B2 is coupled to DQ4, B3 238 is coupled to DQ0, and B4 240 is coupled to DQ1. Similarly, on the fourth device 208, B0 242 is coupled to DQ3, B1 244 is coupled to DQ4, B2 246 is coupled to DQ0, B3 248 is coupled to DQ1, and B4 250 is coupled to DQ2; and on the fifth device 210, B0 252 is coupled to DQ4, B1 254 is coupled to DQ0, B2 256 is coupled to DQ1, B3 258 is coupled to DQ2, and B4 260 is coupled to DQ3.

The rotation of the LSB connection B0 (and other lines B1-BN) to the bus lines in this novel manner has several key advantages over known art, enabling simplified enumeration of devices; simplified arbitration for bus ownership, requiring minimal logic in each device; and simplified handling of devices which may be in a power-down or sleep mode to conserve power.

Enumeration of each device on the bus is denoted physically by the unique connection of its B0-B4 pins to bus lines DQ0-DQ4. When a known data pattern (for example B0 “1”, all other lines B2 through B4 “0”) is applied by a single device, all other devices can determine the enumeration of this transmitting device by noting on which input B1-B4 the data is received. For example, B0 of device 202 always appears at B4 of device 204, B3 of device 206, B2 of device 208, and B1 of device 210. A similar correlation exists for B0 output from any of the five devices; a simple mapping in each device therefore signals which other device has gained ownership of the bus. In some systems there is no requirement for enumeration, and no mapping is required.

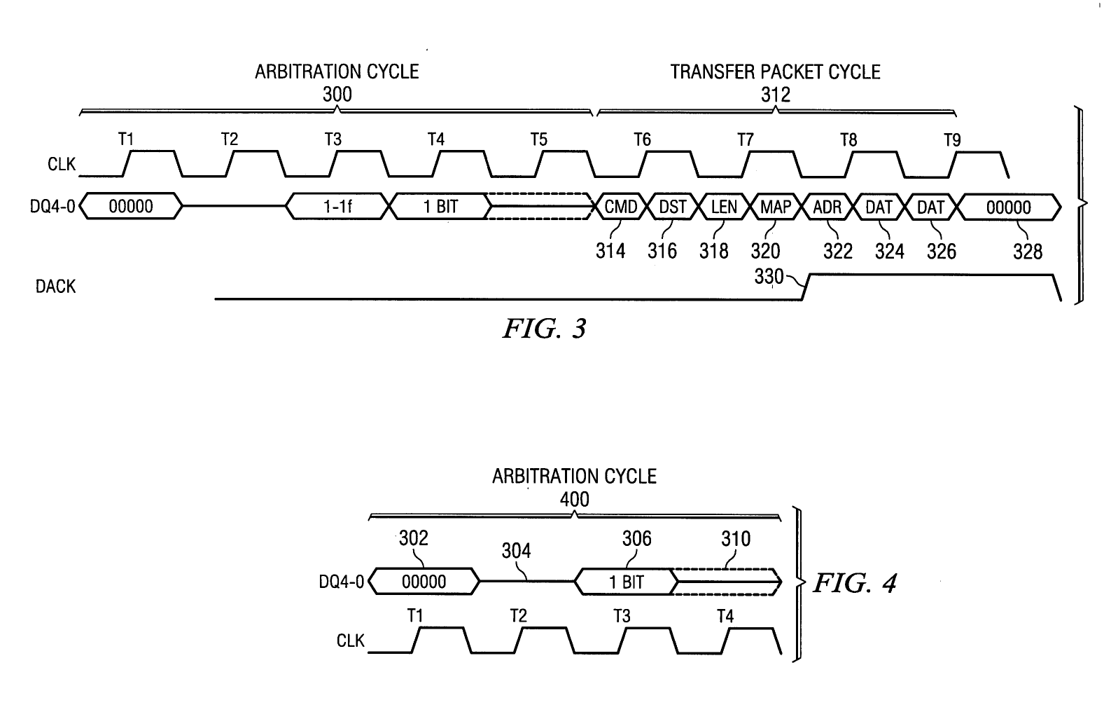

FIG. 3 is a timing diagram showing normal operation of the VLMMB, with multiple devices requesting bus ownership. The timing diagram details events during the arbitration process and the data transfer process. Arbitration is the process by which one device, of the one or more having data for transmission at a given time, gains ownership (control) of the bus for some period of time. In a typical bus scheme, only one device should be placing data on the bus (driving the bus) at any time, to avoid data collisions and resulting errors. The timing diagram includes an arbitration cycle 300 and a transfer packet cycle 312. In the present example, the arbitration cycles 300 comprises the five clock cycles, T1 through T5 of CLK. During the first clock cycle T1, the last device having the ownership of the bus outputs a “0” on all its B0-B4 lines thus driving all bus lines DQ0-DQ4 to “0”. This signals all devices coupled to the bus that the bus arbitration is beginning. During the next clock cycle T2, all devices enter a tri-state condition on all their lines B0-B4. During the next clock cycle T3, any device which desires ownership of the bus raises its B0 line to “1”. Because of the bit-rotated coupling of devices, even if all devices raise their B0 to “1” there is no collision on the bus. During the cycle T3, some or all of the DQ0-DQ4 will be logically “1”, depending on the number of devices requesting the bus ownership.

After raising its B0 line to “1”, each device desiring the ownership of the bus, reads the status of DQ0-DQ4 lines to determine which other device also desires the ownership and determines whether to remain in a requesting state (B0=“1”) or drop its request for the bus. This determination is typically made by 1) a hierarchical ordering, wherein each device is given a priority level, and the device with the highest priority gains bus ownership; or 2), round-robin, where each device takes its turn, in order, or 3) some combination of hierarchical and round-robin. If hierarchical arbitration is used, each device is given a priority (for example, in the range 1 to 5 for a 5-device system) and a table of priorities of all other devices on the system. When a requesting device sees other devices also requesting the ownership, each device compares its priority level to that of other requesters to decide whether to drop or maintain its request. The round-robin arbitration typically uses a memory element (counter) in each device N to store which device N-X last had its turn at the bus ownership (whether that turn was used or not), and logic to determine if any devices between device N-X and device N are requesting ownership; if not, device N gains control of the bus. This round-robin approach gives devices ownership in turn, but avoids wasting “turns” of devices not requesting the ownership. Simpler round-robin approaches are known as well. Various combinations of hierarchical and round-robin arbitration can be used as needed. Other approaches to contention handling can also be used, taking advantage of the fact that all devices desiring ownership know which other devices also desire the ownership.

At the end of the clock cycle T3, the arbitration described above leaves a single device with its B0 “1” during the next clock cycle T4 thus asserting control of the bus and signaling to all other devices the winner of the arbitration phase. During the clock cycle T5, all other devices tri-state their outputs and prepare to listen for data from the device about to transmit, which continues to hold its B0 line at “1” as indicated by the dashed line in cycle 310 on DQ4-0.

FIG. 4 is a timing diagram of the VLMMB, with a single device requesting the bus ownership during the arbitration cycle 400. The arbitration proceeds as described above with reference to FIG. 3 through cycles 302, 304, and 306; however, seeing only a single requester during cycle 306, there is no need for cycle 308, so the operation of clock cycle T4 is omitted. Arbitration thus completes in 4 rather than 5 clock cycles, reducing the overhead.

Referring to FIG. 3, when the bus arbitration is complete, the transfer packet cycle 312 begins. The specific makeup of the data packets during this transfer packet cycle 312 can be tailored to the specific needs of a given system; the embodiment described herein is given as an example. During cycle 314, a 4-bit data word is transmitted using double-data-rate (DDR) clocking on those lines of DQ0-DQ4 that correspond to the data lines of the device with bus ownership (i.e., the device that won the arbitration and is now transmitting data on the bus). During this period and until the completion of data transfer, the transmitting device ensures that at least one of its lines B0-B4 is at logic “1”, typically by computing odd parity and placing the result on one of the lines B0-B4, or by use of RLL coding of the data as described above.

The received data is bit-rotated due to the bit-rotated connection of each device to the bus. De-rotation of the receive data word is typically (and simply) achieved by the receiving device noting which of its lines B0-B4 was logic “1” during arbitration cycle 308 or 310 of FIG. 3. At cycle 308 and 310, only the device with ownership will have its B0 line “1”. For example, a receiving device seeing “1” on its B3 line during cycle 308 or 310 would de-rotate 3 bits; seeing a “1” on its B1 line it would de-rotate 1 bit.

In the example embodiment with data format as shown in FIG. 3, the 4-bit command CMD during cycle 314 signals all listening devices (that is, those not asleep or powered down) what type of data will follow, and in some cases what to do with the data. The DST data in cycle 316 identifies the destination device for the data; the LEN data 318 identifies the length, in bytes, of the data to follow; the MAP word 320 is used in conjunction with the ADR word 322 to identify the memory address in the receiving device to which the following data is to be written; DAT words 324 and 326 are the actual 8 bits (or more) of data (depending on the LEN parameter, more than two DAT packets may be sent before the end of the transfer packet cycles). Typically the DACK line goes to logic “1” at time 330, some time after the CMD and DST packets have been sent. The DACK line is driven high by the destination device, and signifies that device is ready to accept the data destined for it (or is ready to supply data being requested). If no DACK is received (DACK line stays low), the transfer is aborted and a retry is attempted at a later time. Upon completion of data transmission, at period 328, the transmitting device takes all of its lines B0-B4 to “0”, signaling the start of the next arbitration phase. The process arbitration/transfer repeats as necessary to transfer data among devices.

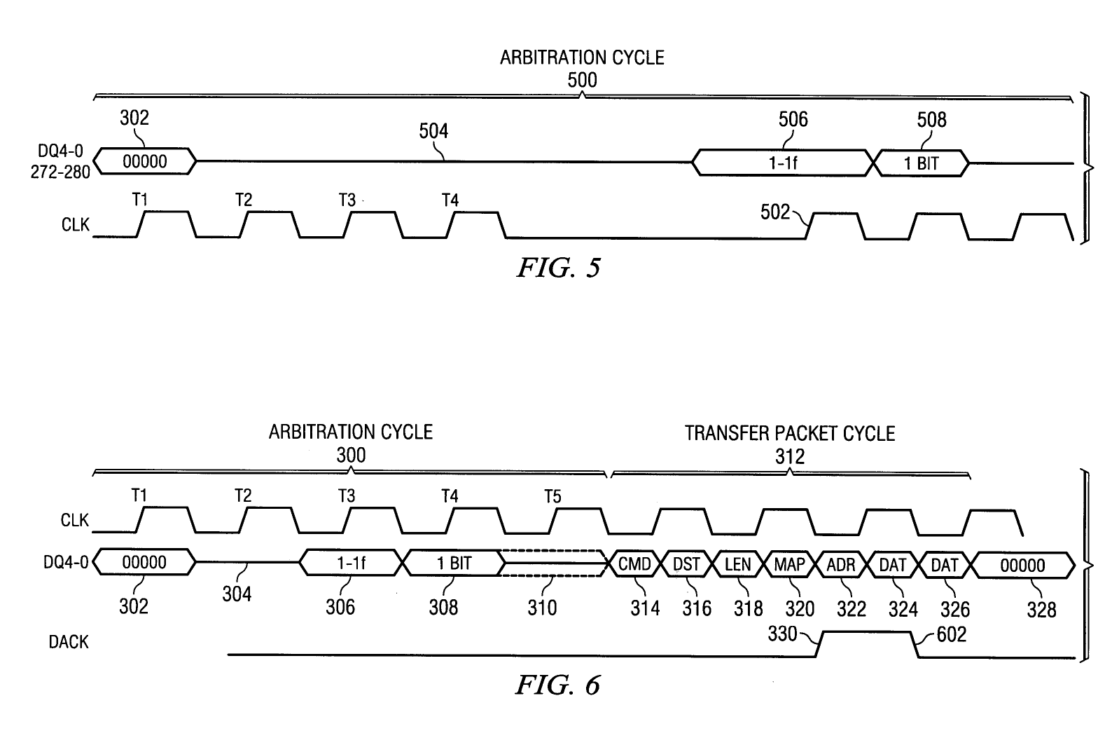

FIG. 5 is a timing diagram illustrating the clock stopping when no ownership requests are present, and restarting when one or more devices on the VLMMB request ownership. FIG. 5 illustrates a special case of the arbitration process described in FIG. 3. In this case, the arbitration cycle 500 is begins at cycle 302 centered on clock cycle T1; however, at this time there is no device requesting the ownership of the bus, hence no assertion of “1” on B0 at the clock cycle T3. In this case, the clock CLK is halted to further reduce system power. At some future time when a device 202-210 needs the ownership of the bus, it simply takes its B0 line high as shown at time 506. Edge detection logic in the device sourcing the clock (or elsewhere in the system) senses this data activity and restarts the clock CLK at edge 502.

Another advantage of the bus architecture of this embodiment is its ability to deal with devices on the bus that may enter sleep or power-down modes to conserve energy. During sleep or power-down, any inactive device typically presents a high-impedance (tri-state condition) to the bus lines. On awakening, the device simply waits for the next arbitration phase signified by “0” on all lines DQ0-DQ4, and proceeds with arbitration as detailed above. If the device has been powered down and has lost knowledge of its “turn” in a round-robin arbitration scheme, it will wait until it again determines the order before requesting ownership.

FIG. 6 is a timing diagram illustrating data flow control on the VLMMB. The data flow control is facilitated by the DACK line, which is a single bus line connecting all of the DACK pins of the devices 202-210 on the bus. The device being addressed in a particular data transfer (for example, the device to which data packets are being sent) uses the DACK line (taking it to logic “1” level) as an acknowledgement that it is ready to accept data and process it as commanded. If a device is addressed, but can't accept the command or data at this time, it leaves the DACK line at “0”, and the transmitting device aborts the transaction and awaits a later retry. If the addressed device is able to accept data, it raises the DACK line to “1” as at 330 and begins data reception, or begins carrying out the command sent to it. If, during the transfer cycles, the receiving device can no longer take data, it lowers the DACK line as shown at time 602, and the transmitting device stops data flow. If some data had been passed (such as DAT 324), the transmitting device remembers at what point the transfer was interrupted, and resumes data transfer at some later time, picking up where it left off to avoid the need to re-transmit data already successfully passed. Such a transaction is typically known as a split transaction.

Flow control can be optimized through protocol design. An upper bound on data latency can be set by limiting the number of data packets sent before arbitration re-starts. This sets the maximum time a device having high priority data to send must wait for the next arbitration opportunity. For example, given a 62.5 MHz clock and DDR clocking of 4-bit data words, 64 data bytes are sent in 64 clock cycles (1.024 microseconds). Thus, with a limit of 64 data bytes per arbitration/transfer cycle, a device with high-priority data waits no more than approximately 1 microsecond (not counting overhead) for another chance to arbitrate for ownership of the bus. The hardware and software logic required to implement a system using the exemplary embodiments described herein for VLMMB is significantly less than the known art. The exemplary embodiments simplify the bus arbitration and enumeration.

The arbitration start cycle at clock cycle T1 is the only time that all lines DQ0-DQN will be at logic “0”. Thus, recognition of the entry of arbitration at clock cycle T1 by any device 202-210, requires only a logical NOR of the five bus data lines DQ0-DQ4. The output of such a logical NOR gate will be “1” only during the arbitration cycle at T1. Similarly, during cycle T3 (the time during which any device desiring bus ownership takes its B0 to “1”), the same NOR gate output will be “0” only if one or more devices are requesting ownership. During this same cycle, devices requesting ownership are determined (enumerated) simply by reading the state of lines DQ0-DQ4. If hierarchical arbitration is in use, a simple map of priority levels of all devices, plus minimal hardware logic, allows any device to determine during cycle T3 if it has the highest priority of those requesting ownership. Known art solutions require either more lines on the bus, or a more complex protocol with software support to handle enumeration, arbitration, and flow control.

The novel features of the example embodiment can be applied to other variants of data bus. For example, given a 62.5 MHz clock and DDR clocking:
1) a 4-pin variant (DQ0, DQ1, CLK, DACK) having a 1-bit data bus and 2 devices; 125 Mbps raw data rate can be achieved.
2) a 5-pin variant (DQ0, DQ1, DQ2, CLK, DACK) having a 2-bit data bus and 3 devices; 250 Mbps raw data rate can be achieved.
3) an 11-pin variant (DQ0, DQ1, DQ2, DQ3, DQ4, DQ5, DQ6, DQ7, DQ8, CLK, DACK) having an 8-bit data bus and 9 devices; 1000 Mbps raw data rate can be achieved.

The most general variant is an N-pin variant, with N-3 bit data bus and N-2 devices, at clock rate F MHz, with or without DDR clocking. Another variant use all available lines DQ0-DQN for data, rather than reserving one for parity. This increases bus bandwidth, especially for those buses with very limited number of connections. For example, a 5-wire bus (DQ0, DQ1, DQ2, CLK, DACK), with three devices, using three data lines DQ0, DQ1, and DQ2 has nearly 50% more throughput can be achieved than a bus using only two of the DQ lines for data packet transfer. In this case, devices on the bus are designed to ignore an all-0's condition on data lines DQN during the data packet DAT times. This approach is facilitated if the protocol, as described herein, uses a LEN (length) descriptor preceding DAT (data) packets, to indicate how many data packets follow. An alternative approach using all DQ lines for data, while avoiding data “0”, is to RLL code the data as described above. Finally, all other data packets sent in the transfer packets cycles must be constrained to avoid an all-zero condition on DQ0-DQN (for example by reserving one of the DQN lines and holding it at logic “1”, or using odd parity as described above). In the exemplary embodiment described above, certain logic levels and timing relationships are described; functional equivalence is achievable with opposite or alternative logic levels and/or alternative timing relationships.

Those skilled in the art to which the invention relates will appreciate that yet other substitutions and modifications can be made to the described embodiments, without departing from the spirit and scope of the invention as described by the claims below. Realizations in accordance with the present invention have been described in the context of particular embodiments. These embodiments are meant to be illustrative and not limiting. Many variations, modifications, additions, and improvements are possible. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed is:

1. A method of arbitrating use of a data communication medium comprising a plurality of data transmission lines, for a plurality of devices configured to share the data communication medium, the method comprising:
coupling the plurality of devices to the data communication medium in a bit rotated manner, wherein each input/output pin of each one of the plurality of devices is coupled to a different data transmission line of the data communication medium than a corresponding input/output pin of other devices within the plurality of devices;
indicating a desire to use the data communication medium for one or more devices by asserting a signal on a predetermined input/output pin of the one or more devices;
identifying a device having a priority for the use of the data communication medium; and
communicating data on the data communication medium for the identified device.

2. A method according to claim 1, wherein the device having a priority for the use for the data communication medium is identified using one or more of a hierarchical priority scheme for each device, a round-robin scheme for each device, and a combination of the hierarchical and round-robin schemes.

3. A method according to claim 1, wherein
the data communication medium comprises at least as many data transmission lines as there are input/output pins for a device; and
the data communication medium further comprises one or more additional data transmission lines for control signals.

4. A method according to claim 1, wherein the data communication medium is a very little multi-master bus.

5. A method according to claim 4, further comprising:
receiving data on the data communication medium at a first device;
bit-rotating the received data, wherein the received data is bit-rotated according to the coupling of the input/output pins of the first device to the data transmission lines of the very little multi-master bus.

6. A data communication unit comprising:
a plurality of devices configured transmit/receive data on a plurality of input/output pins;
a data bus comprising a plurality of data transmission lines, wherein the plurality of devices are coupled to the data bus in a bit rotated manner, wherein each input/output pin of each one of the plurality of devices is coupled to a different data transmission line of the data bus than a corresponding input/output pin of other devices within the plurality of devices;

7. A data communication unit according to claim 6, wherein the data communication unit is configured to:
identify a device having a priority for the use of the data bus; wherein the device having a priority for the use for the data communication medium is identified using one or more of a hierarchical priority scheme for each device, a round-robin scheme for each device, and a combination of the hierarchical and round-robin schemes.

8. A data communication unit according to claim 6, wherein
the data bus comprises at least as many data transmission lines as there are input/output pins for a device; and
the data bus further comprises one or more additional data transmission lines for control signals.

9. A data communication unit according to claim 8, wherein the data bus is a very little multi-master bus.

10. A data communication unit according to claim 8, wherein each one of the plurality of devices is configured to:
receive data on the data bus; and
bit-rotate the received data, wherein the received data is bit-rotated according to the coupling of the input/output pins of each one of the plurality of devices to the data transmission lines of the very little multi-master bus.
